(19) United States
(12) Patent Application Publication
(10) Pub. No.: US 2006/0283212 A1
(43) Pub. Date: Dec. 21, 2006

(54) Tile sponge washing and conditioning apparatus

(76) Inventor: Rodney W. Wilson, Wisconsin Dells, WI (US)

Correspondence Address: DAVID J. ARCHER, 7037 POMERY ROAD, ROCKTON, IL, 61072, US

(21) Appl. No.: 11/437,854

(22) Filed: May 20, 2006

Related U.S. Application Data
(63) Continuation-in-part of application No. 11/173,662, filed on Jul. 1, 2005.
Application No. 11/173,662 is a continuation-in-part of application No. 10/799,833, filed on Mar. 13, 2004.

(51) Int. Cl. B08B 3/00; D06F 9/00

(52) U.S. Cl. 68/84; 134/84

(57) ABSTRACT

A tile sponge washing and conditioning apparatus is disclosed for washing in water a sponge used during a ceramic tile grouping operation. The apparatus includes a frame for disposition thereof within the water. The frame includes a first wall and a second wall which is disposed spaced from the first wall. A first roller has an axis of rotation which extends through the walls and a second roller has a rotational axis which extends through the walls. The rollers cooperate with each other to define therebetween a passageway for the passage therethrough of the sponge to be washed and conditioned such that when the rollers are counter rotated relative to each other, the sponge is squeezed and driven through the passageway so that the sponge is washed and conditioned by the water during passage of the sponge through the passageway. An electric motor is drivingly connected to at least one of the rollers for rotating the rollers. Also, an electrical battery supplies electrical power to the motor for energizing the motor.

### CROSS REFERENCE TO RELATED APPLICATION

The present application is a continuation in part of co-pending patent application U.S. Ser. No. 11/173,662 which is a continuation in part of co-pending patent application U.S. Ser. No. 10/799,833 filed Mar. 13th 2004. All the disclosure of the aforementioned applications is incorporated herein by reference.

### FIELD OF THE INVENTION

1. Background of the Invention

The present invention relates to a tile sponge washing and conditioning apparatus. More specifically, the present invention relates to a tile sponge washing and conditioning apparatus for washing in water a sponge used during a ceramic tile grouting operation.

2. Background Information

A tile laying operation includes laying the tiles onto a layer of adhesive. When the adhesive has set, a grouting compound is applied to the tiles for filling the spaces between adjacent tiles. Excess grout must be removed from the tiles before the grout hardens. In order to remove such excess grout, a dampened sponge is applied to the surface of the tile and wiped across the upper surface of the tile for removing the excess grout from the tiles. The initial process of removing excess grout entails the removal of a considerable amount of grout. Therefore, it is essential that the sponge be frequently immersed into clean water to wash away such excess grout from the sponge. Typically, the sponge is submerged in a bowl of water and is hand squeezed in order to release the grout on the sponge into the bowl of water.

The aforementioned process is time consuming because it is essential that the sponge be frequently cleaned in order to progressively remove the excess grout from the tiles. Also, because the grout has a damaging effect on the skin, the tiler should wear protective gloves when washing and conditioning the sponge in the bowl of water.

The apparatus according to the present invention overcomes the aforementioned problems by the provision of an apparatus which is at least partially immersed in a container of water. In operation of the apparatus, a sponge to be cleaned and conditioned is inserted between counter rotating beaters which feed the sponge through the water in the container and progressively squeeze and release the sponge so that the excess grout is removed from the sponge into the water as the sponge progresses through the apparatus. When the sponge emerges from the apparatus, the sponge has been thoroughly washed and conditioned and is ready for further use on the surface of the tiles for removing further excess grout therefrom. Also, while one sponge is being washed by the apparatus of the present invention, another sponge previously washed and conditioned is used in the removal of excess grout so that no time is wasted waiting for a sponge to be cleaned.

The apparatus according to the present invention cuts down on the time needed to complete a tiling project. Also, the apparatus protects a tiler's hands from the damage caused by immersing the tiler's hands in a bowl of sponge washing water.

Therefore, a primary feature of the present invention is the provision of a tile sponge washing and conditioning apparatus for washing in water a sponge used during a ceramic tile grouting operation that overcomes the problems associated with the prior art arrangements.

Another feature of the present invention is the provision of a tile sponge washing and conditioning apparatus that reduces the time required to complete a tiling project.

A further feature of the present invention is the provision of a tile sponge washing and conditioning apparatus that protect the tiler's hands from the damage caused by immersion of a tiler's hands in a bowl of water used to wash grout away from a sponge.

Other features and advantages of the present invention will be readily apparent to those skilled in the art by a consideration of the detailed description of a preferred embodiment of the present invention contained herein.

### SUMMARY OF THE INVENTION

The present invention relates to a tile sponge washing and conditioning apparatus. The apparatus is used for washing in water a sponge used during a ceramic tile grouting operation. The apparatus includes a frame for disposition thereof within the water. The frame includes a first wall and a second wall which is disposed spaced from the first wall. A first roller has an axis of rotation which extends through the walls and a second roller has a rotational axis which extends through the walls. The rollers cooperate with each other to define therebetween a passageway for the passage therethrough of the sponge to be washed and conditioned such that when the rollers are counter rotated relative to each other, the sponge is squeezed and driven through the passageway so that the sponge is washed and conditioned by the water during passage of the sponge through the passageway. An electric motor is drivingly connected to at least one of the rollers for rotating the rollers. Also, an electrical battery supplies electrical power to the motor for energizing the motor.

In a more specific embodiment of the present invention, the battery is a rechargeable battery. Also, the frame is fabricated from stainless steel.

More specifically, the first wall is of planar configuration the first wall having a first and a second edge, a top and a bottom edge and an inner and an outer surface. The second wall is of planar configuration the second wall having a first and a second side, a top and a bottom end and an inner and an outer face, the second wall being disposed parallel relative to the first wall.

Furthermore, the apparatus includes a plurality of counter rotating beaters rotatably supported between the walls for defining the passageway so that as the sponge is progressively driven along the passageway, the sponge is progressively washed and conditioned.

Many modifications and variations of the present invention will be readily apparent to those skilled in the art by a consideration of the detailed description contained hereinafter taken in conjunction with the annexed drawings which show a preferred embodiment of the present invention. However, such modifications and variations fall within the spirit and scope of the present invention as defined by the appended claims.

### BRIEF DESCRIPTION OF THE DRAWING

FIG. 1 is a side elevational view of a tile sponge washing and conditioning apparatus according to the present invention; and

FIG. 2 is a view taken on the line 2-2 of FIG. 1.

Similar reference characters refer to similar parts throughout the various views of the drawings.

### DETAILED DESCRIPTION OF THE DRAWING

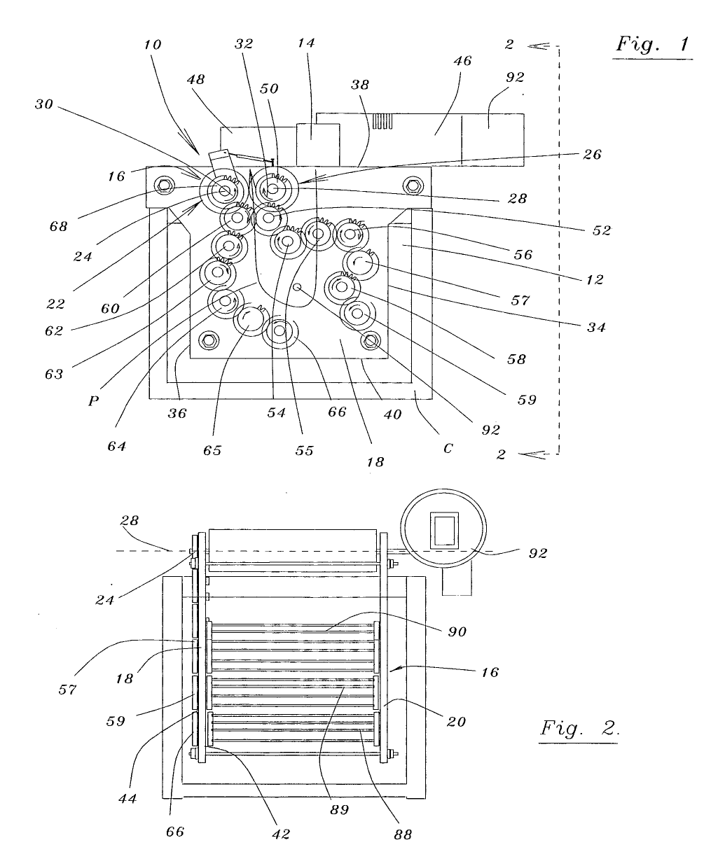

FIG. 1 is a side elevational view of a tile sponge washing and conditioning apparatus generally designated 10 according to the present invention. As shown in FIG. 1, the apparatus 10 is disposed within a container C which is filled with water 12. The water 12 is for washing a sponge 14 used during a ceramic tile grouting operation. As shown in FIG. 1, the apparatus 10 includes a frame generally designated 16 for disposition thereof within the water 12. The frame 16 includes a first wall 18.

FIG. 2 is a view taken on the line 2-2 of FIG. 1. As shown in FIG. 2, the frame 16 includes a second wall 20 which is disposed spaced from and parallel to the first wall 18. A first roller generally designated 22 has an axis of rotation 24 which extends through the walls 18 and 20 respectively. Also, a second roller generally designated 26 has a rotational axis 28 which also extends through the walls 18 and 20 respectively. As shown in FIG. 1, the rollers 22 and 26 cooperate with each other to define therebetween a passageway indicated by the arrow P for the passage therethrough of the sponge 14 to be washed and conditioned. The arrangement is such that when the rollers 22 and 26 are counter rotated relative to each other as indicated by the arrows 30 and 32 respectively, the sponge 14 is squeezed and driven through the passageway P so that the sponge 14 is washed and conditioned by the water 12 during passage of the sponge 14 through the passageway P.

In a more specific embodiment of the present invention, the frame 16 is fabricated from stainless steel.

Additionally, as shown in FIG. 2, the first wall 18 is of planar configuration. As shown in FIG. 1, the first wall 18 has a first and a second edge 34 and 36 respectively, a top and a bottom edge 38 and 40 respectively.

As shown in FIG. 2, the wall 18 also has an inner and an outer surface 42 and 44 respectively.

Also, as particularly shown in FIG. 1, an electric motor 46 drives a transmission 48 for driving a first gearwheel 50 about the rotational axis 28 so that the second roller 26 is rotated. The gearwheel 50 intermeshes with a second gearwheel 52 which in turn intermeshes with and drives a series of gearwheels 54, 55, 56, 57, 58 and 59. The second gearwheel 52 also intermeshes with and drives a third gearwheel 60. The third gearwheel 60 in turn intermeshes with and drives gearwheels 62, 63, 64, 65 and 66. The third gearwheel 60 also drives a fourth gearwheel 68 for rotating the first roller 22.

Gearwheels 54,57, 59, 66, 64 and 62 are drivingly secured to rotatable beaters. FIG. 2 shows beaters 88, 89 and 90 drivingly secured to gearwheels 66, 59 and 57 respectively. Also, as shown in FIG. 1, an axle 92 is secured to a further beater (not shown). The further beater is of the same dimensions as the other beaters. However, the further beater is not connected to or driven by any of the gearwheels so that the further beater is able to free wheel in either rotational direction. As shown, the beaters define the passageway P so that the sponge 14 is agitated by the beaters and the sponge 14 is urged by the beaters along the passageway P towards the counter rotating rollers 22 and 26 for squeezing water from the sponge 14.

In operation of the apparatus according to the present invention, the sponge 14 that has been used for removing excess grout from freshly laid tiles is placed between the counter rotating beaters driven by gearwheels 54 and 57 respectively. The agitated sponge 14 progresses along the passageway P and is further agitated and driven between the beater driven by the gearwheel 59 and the free wheel further beater rotating about axle 92. The sponge 14 is further agitated as it is urged along the passageway P by the remaining counter rotating beaters and is ejected through the nip defined between the rollers 22 and 26.

As shown in FIG. 1, the electric motor 46 is energized by a rechargeable cell 92 so that the apparatus 10 can be operated on a site without an electrical power outlet.

The present invention provides a unique apparatus for washing and conditioning a grouting sponge which greatly reduces the time taken to complete a grouting project and which also protects the tiler's hands from excessive contact with the grout.

What is claimed is:

1. A tile sponge washing and conditioning apparatus for washing in water a sponge used during a ceramic tile grouting operation, said apparatus comprising:
a frame for disposition thereof within the water, said frame including:
a first wall;
a second wall disposed spaced from said first wall;
a first roller having an axis of rotation which extends through said walls;
a second roller having a rotational axis which extends through said walls;
said rollers cooperating with each other to define therebetween a passageway for the passage therethrough of the sponge to be washed and conditioned such that when said rollers are counter rotated relative to each other, the sponge is squeezed and driven through said passageway so that the sponge is washed and conditioned by the water during passage of the sponge through said passageway;
an electric motor drivingly connected to at least one of said rollers for rotating said rollers; and
an electrical battery for supplying electrical power to said motor for energizing said motor.

2. A tile sponge washing and conditioning apparatus as set forth in claim 1 wherein said battery is a rechargeable battery.

3. A tile sponge washing and conditioning apparatus as set forth in claim 1 wherein
said frame is fabricated from stainless steel.

4. A tile sponge washing and conditioning apparatus as set forth in claim 1 wherein
said first wall is of planar configuration said first wall having a first and a second edge, a top and a bottom edge and an inner and an outer surface;
said second wall is of planar configuration said second wall having a first and a second side, a top and a bottom end and an inner and an outer face, said second wall being disposed parallel relative to said first wall.

5. A tile sponge washing and conditioning apparatus as set forth in claim 1 further including:
a plurality of counter rotating beaters rotatably supported between said walls for defining said passageway, said beaters being driven by said motor so that as the sponge is progressively driven along said passageway, the sponge is progressively washed and conditioned.

6. A tile sponge washing and conditioning apparatus for washing in water a sponge used during a ceramic tile grouping operation, said apparatus comprising:
a frame for disposition thereof within the water, said frame including:
a first wall;
a second wall disposed spaced from said first wall;
a first roller having an axis of rotation which extends through said walls;
a second roller having a rotational axis which extends through said walls;
said rollers cooperating with each other to define therebetween a passageway for the passage therethrough of the sponge to be washed and conditioned such that when said rollers are counter rotated relative to each other, the sponge is squeezed and driven through said passageway so that the sponge is washed and conditioned by the water during passage of the sponge through said passageway;
an electric motor drivingly connected to at least one of said rollers for rotating said rollers; and
a rechargeable electrical battery for supplying electrical power to said motor for energizing said motor.

7. A tile sponge washing and conditioning apparatus for washing in water a sponge used during a ceramic tile grouping operation, said apparatus comprising:
a frame for disposition thereof within the water, said frame including:
a first wall;
a second wall disposed spaced from said first wall;
a first roller having an axis of rotation which extends through said walls;
a second roller having a rotational axis which extends through said walls;
said rollers cooperating with each other to define therebetween a passageway for the passage therethrough of the sponge to be washed and conditioned such that when said rollers are counter rotated relative to each other, the sponge is squeezed and driven through said passageway so that the sponge is washed and conditioned by the water during passage of the sponge through said passageway;
an electric motor drivingly connected to at least one of said rollers for rotating said rollers;
an electrical battery for supplying electrical power to said motor for energizing said motor;
said battery is a rechargeable battery;
said frame is fabricated from stainless steel;
said first wall is of planar configuration said first wall having a first and a second edge, a top and a bottom edge and an inner and an outer surface;
said second wall is of planar configuration said second wall having a first and a second side, a top and a bottom end and an inner and an outer face, said second wall being disposed parallel relative to said first wall; and
a plurality of counter rotating beaters rotatable supported between said walls for defining said passageway, said beaters being driven by said motor so that as the sponge is progressively driven along said passageway, the sponge is progressively washed and conditioned.
